(19) United States
(12) Patent Application Publication
(10) Pub. No.: US 2019/0032743 A1
(43) Pub. Date: Jan. 31, 2019

(54) DAMPING FORCE VARIABLE VALVE

(71) Applicant: AISIN SEIKI KABUSHIKI KAISHA, Kariya-shi (JP)

(72) Inventor: Kosuke SAKAI, Obu-shi (JP)

(73) Assignee: AISIN SEIKI KABUSHIKI KAISHA, Kariya-shi (JP)

(21) Appl. No.: 16/033,433

(22) Filed: Jul. 12, 2018

(30) Foreign Application Priority Data
Jul. 31, 2017 (JP) 2017-147950

(51) Int. Cl. F16F 9/34; F16F 9/348; F16F 9/46

(52) U.S. Cl. CPC F16F 9/34; F16F 9/348; B60G 17/08; F16F 2228/066; F16F 9/46

(57) ABSTRACT

A damping force variable valve includes: a case that accommodates a working fluid therein; and a housing that divides an inside of the case into a first fluid chamber and a second fluid chamber. The housing includes first and second housings, which are adjacent to each other along a direction of an axis of the case. Inside the first housing, a control mechanism that controls an operation speed of the housing by adjusting a flow rate of the working fluid circulating through the first fluid chamber and the second fluid chamber is provided. The control mechanism includes: a first pilot chamber that communicates with the first fluid chamber through a first orifice; a second pilot chamber that communicates with the second fluid chamber through a second orifice; and a valve body that changes a posture while separating the first pilot chamber and the second pilot chamber from each other.

### CROSS REFERENCE TO RELATED APPLICATIONS

This application is based on and claims priority under 35 U.S.C. § 119 to Japanese Patent Application 2017-147950, filed on Jul. 31, 2017, the entire contents of which are incorporated herein by reference.

### TECHNICAL FIELD

This disclosure relates to a damping force variable valve, which includes a case, which accommodates a working fluid therein, and a housing, which divides the inside of the case into a first fluid chamber and a second fluid chamber and reciprocates inside the case along the axis of the case, the damping force variable valve controlling an operation of a valve body provided in the housing to adjust the operating characteristics of the housing.

### BACKGROUND DISCUSSION

In the related art, such a damping force variable valve is disclosed in, for example, JP07-071502A (Reference 1).

This technique relates to a damping force variable valve provided in a suspension of a vehicle or the like, and the damping force variable valve operates a valve mechanism using an actuator to control the flow characteristics of a working fluid so as to adjust a buffering effect. In particular, in a device of Reference 1, in order to prevent a buffering function from being impaired by the leakage of the working fluid from the inside of the valve mechanism, the volume of the space, in which the working fluid circulates, is reduced.

That is, in the technique of Reference 1, a housing 2 is provided inside a cylinder 4, in which a working fluid is sealed. The housing 2 may reciprocate while dividing the inner space of the cylinder 4 into two operating spaces 33 and 35. A tubular anchor 51, which is operated by an actuator, and a sleeve 53, which is in contact with the anchor 51, are provided inside the housing. A first slit, through which the working fluid circulates, is formed between the anchor 51 and the sleeve 53. By changing the position of the anchor 51, the flow rate of the working fluid is changed, and thus the movement speed of the housing is controlled.

Two systems of valve bodies 21a and 21b are provided inside the housing 2. Thereby, during the reciprocation of the housing, it is possible to obtain a one-way function for causing a predetermined amount or more of working fluid to circulate through one operating space 33 and the other operating space 35.

In addition, flow paths are provided in the respective valve bodies 21a and 21b to cause a smaller amount of working fluid to circulate therethrough, and check valves 37a and 37b are provided in the respective flow paths. Inside the housing 2, the two valve bodies are disposed to face each other along the direction of the axis with a common control space 19 interposed therebetween. In particular, when a small amount of working fluid circulates so as to make the movement speed of the housing 2 slow, the working fluid is introduced into the common control space 19 via the check valve 37a or 37b. The fluid inside the control space 19 is discharged to the operating space 33 or 35 opposite to the operating space into which the working fluid has been introduced through the first slit formed between the anchor 51 and the sleeve 53.

As described above, by providing the respective valve bodies 21a and 21b inside the housing 2 and further providing the flow paths and the check valves 37a and 37b in the valve bodies 21a and 21b, the number of components of a shock absorbing apparatus is reduced and the overall structure thereof is simplified. As a result, the flow path of the working fluid is reduced, whereby a reduction in the chance of leakage of the working fluid or improvement in buffering function is expected.

In the damping force variable valve disclosed in Reference 1, two systems of valve mechanisms are disposed inside the housing 2, and the housing 2 is connected to a connection portion, which integrally extends in the direction of the axis from a member, which holds the actuator. Therefore, the housing 2 is elongated in the axial direction in order to hold the two systems of valve mechanisms.

In addition, although the housing 2 is connected to the actuator, there is a disadvantage in that the attachment state of the housing 2 becomes longer due to the connection portion existing between the housing and the actuator, and thus it becomes difficult to secure the stroke of the shock absorbing apparatus. As a result, in the damping force variable valve known in the related art, the mountability to a vehicle is poor and buffering performance is inferior in some cases.

Thus, a need exists for a damping force variable valve which is not susceptible to the drawback mentioned above.

### SUMMARY

A feature of a damping force variable valve according to an aspect of this disclosure resides in that the damping force variable valve includes a case that accommodates a working fluid therein, and a housing that divides an inside of the case into a first fluid chamber and a second fluid chamber. The housing includes a first housing and a second housing, which are adjacent to each other along a direction of an axis of the case. Inside the first housing, a control mechanism that controls an operation speed of the housing by adjusting a flow rate of the working fluid circulating through the first fluid chamber and the second fluid chamber is provided. The control mechanism includes a first pilot chamber that communicates with the first fluid chamber through a first orifice, a second pilot chamber that communicates with the second fluid chamber through a second orifice, and a valve body that changes a posture while separating the first pilot chamber and the second pilot chamber from each other. Inside the second housing, an adjustment mechanism which adjusts a degree of change in the posture of the valve body so as to set an amount of circulation of the working fluid through the first pilot chamber and the second pilot chamber, and an actuator which drives the adjustment mechanism are provided. A check valve that is opened when an internal pressure of the first pilot chamber is increased so as to discharge the working fluid from the first pilot chamber to the first fluid chamber is provided at a boundary position between the first housing and the second housing.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory view illustrating a configuration of a damping force variable valve according to a first embodiment;

FIG. 2 is an explanatory view illustrating a configuration of a damping force variable valve according to the first embodiment;

FIG. 3 is an explanatory view illustrating a configuration of a damping force variable valve according to a second embodiment;

FIG. 4 is an explanatory view illustrating a structure of a first check valve according to a third embodiment; and

FIG. 5 is an explanatory view illustrating a structure of a first check valve according to a fourth embodiment.

### DETAILED DESCRIPTION

### First Embodiment

### (Overview)

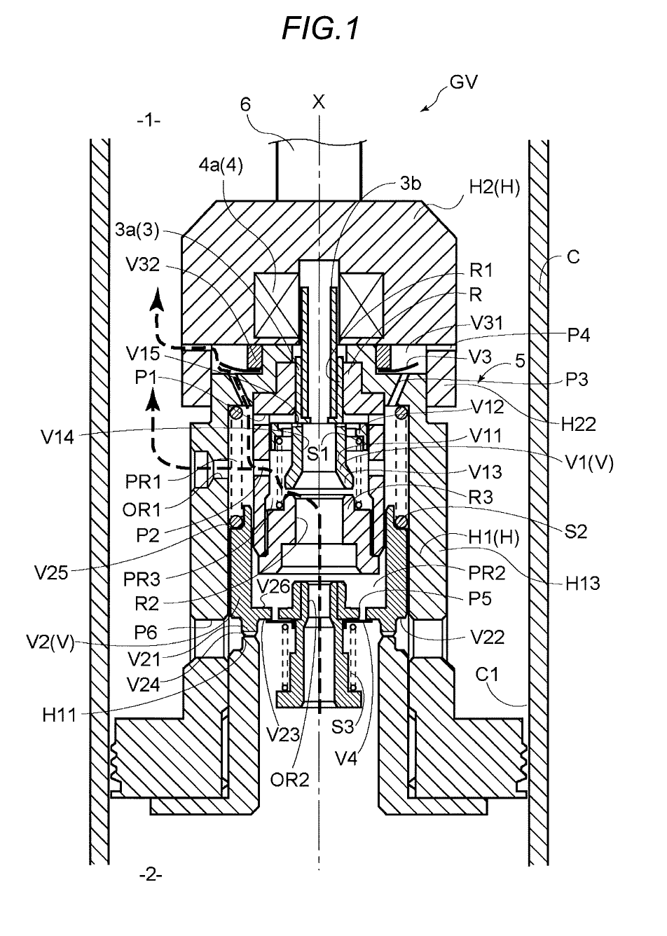

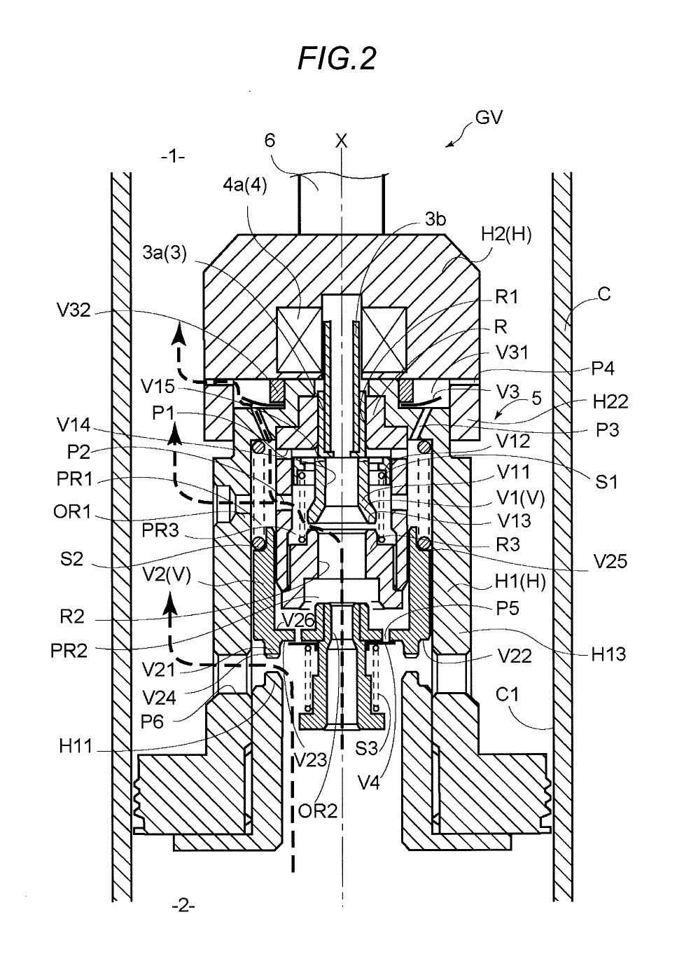

A first embodiment of a damping force variable valve GV disclosed here will be described with reference to FIGS. 1 and 2. The damping force variable valve GV is used for a shock absorber of a vehicle, or the like. For example, a housing H slides relative to an inner surface C1 of a case C, and the movement speed of the housing H is adjusted by changing the flow rate of a working fluid circulating inside the housing H.

### (Case)

The case C has, for example, a cylindrical shape. The housing H is provided inside the case C, and is capable of reciprocating in the direction of the axis X of the case C while being in contact with the inner surface C1 of the case C. The housing H is attached to the tip end of a rod 6, and for example, the other end of the rod 6 is connected to a frame of the vehicle, so that the end portion of the case C is connected to a suspension of a vehicle wheel. The inner space of the case C is divided into a first fluid chamber 1 and a second fluid chamber 2 by the housing H. The housing H includes a first housing H1 and a second housing H2, which are adjacent to each other along the direction of the axis X of the case C. The first housing H1 and the second housing H2 are connected to each other by screwing or fitting.

### (First Housing)

A flow path is set in the first housing H1 to communicate the first fluid chamber 1 and the second fluid chamber 2 with each other. In addition, a control mechanism 5 is provided inside the first housing H1 to control the operation speed of the housing H by adjusting the flow rate of the working fluid circulating through the first fluid chamber 1 and the second fluid chamber 2.

A substantially tubular retainer R is provided inside the first housing H1 so as to form a double structure with respect to the first housing H1. The retainer R accommodates a first valve body V1 to be described later, which is one of valve bodies V. In addition, a second valve body V2 to be described later is accommodated in the space between the first housing H1 and the retainer R. A first pilot chamber PR1 is formed in the space between the first housing H1 and the retainer R, and communicates with the first fluid chamber 1 through a first orifice OR1. The first orifice OR1 is set to have a predetermined opening area, and the flow rate of the working fluid passing therethrough is limited to a predetermined amount. As illustrated in FIG. 1, for example, the first orifice OR1 opens toward the radial direction in the cylindrical sidewall of the first housing H1.

### (Retainer)

The tubular first valve body V1 is disposed inside the retainer R to divide the inner space of the retainer R into two spaces. The first valve body V1 includes a substantially cylindrical body portion V11 and an annular flange portion V12 protruding radially outward from the body portion V11. The first valve body V1 may reciprocate a predetermined distance along the direction of the axis X while sliding the flange portion V12 on the inner surface of the retainer R.

A first port P1 and a second port P2 are provided in the sidewall of the retainer R so as to be spaced apart from each other in the direction of the axis X on the side close to the second housing H2. Among both end portions of the retainer R, the end portion on the side of a solenoid 4a to be described later in the direction of the axis X is formed with a guide hole R1, through which a plunger 3a to be described later is inserted so that the guide hole R1 serves as a guide of the plunger 3a. On the other hand, a bottom hole R2 is formed in the end portion opposite thereto in the direction of the axis X. An annular first valve seat R3 is formed in the bottom hole R2 so as to be in contact with the end portion of the body portion V11 of the first valve body V1.

The first pilot chamber PR1 is formed in the space between the retainer R and the first housing H1. The first pilot chamber PR1 communicates with the first fluid chamber 1 through the first orifice OR1. On the other hand, the first port P1 and the second port P2, provided in the peripheral wall of the retainer R, communicate a third pilot chamber PR3 inside the retainer R with the first pilot chamber PR1. Moreover, the bottom hole R2, provided in the bottom portion of the retainer R, communicates with a second pilot chamber PR2 provided outside the retainer R.

### (Actuator)

In the retainer R, for example, a coil-shaped first spring S1 is provided around the first valve seat R3, and constantly presses the flange portion V12 of the first valve body V1 to the plunger 3a side. The plunger 3a constitutes an adjustment mechanism 3, which is driven by, for example, the solenoid 4a, which serves as an actuator 4 provided in the second housing H2, and adjusts the flow rate of the working fluid by changing the position of the first valve body V1 in the direction along the axis X. Thereby, the first valve body V1 is constantly pressed to the side away from the first valve seat R3. The other end portion of the first valve body V1 in the direction of the axis X is in contact with the tip end of the plunger 3a. Since the first valve body V1, which is pressed by the first spring S1, is constantly in contact with the end portion of the plunger 3a, the position of the first valve body V1 is also moved depending on a change in the position of the plunger 3a in the direction of the axis X.

As the plunger 3a retracts to the solenoid 4a side, the distance between the first valve body V1 and the first valve seat R3 increases, so that the flow rate of the working fluid circulating through the first pilot chamber PR1 and the second pilot chamber PR2, which communicate with each other through the bottom hole R2 in the retainer R, increases. On the other hand, when the plunger 3a is extruded to the third pilot chamber PR3, the other end portion of the first valve body V1 comes into contact with the first valve seat R3. However, at least one of the first valve body V1 and the plunger 3a is formed with a first slit V15, which extends in the radial direction, so that a certain amount of working fluid may circulate therethrough. In the present embodiment, the first slit V15 is formed in the first valve body V1. When the first valve body V1 is at this position, the amount of circulation of the working fluid is minimized, which maximizes the effect of damping the sliding of the housing H.

In the present embodiment, the plunger 3a includes a bar-shaped member 3b. Such a bar-shaped member 3b easily transmits the driving effect of the solenoid 4a to the first valve body V1, which is located at a position spaced apart from the solenoid 4a by a predetermined distance. When the bar-shaped member 3b mainly transmits a driving force in the direction of the axis X, the outer diameter dimension of the bar-shaped member 3b may be smaller than the outer diameter dimension of the solenoid 4a or the first valve body V1. That is, the periphery of the bar-shaped member 3b is used as a guide portion of the bar-shaped member 3b inside the second housing H2, but another space is easily secured since the bar-shaped member 3b is relatively thin. Therefore, with this configuration, the space for the installation of a first check valve V3 to be described later is easily secured, and a more compact damping force variable valve GV can be easily obtained.

### (First Valve Body)

As illustrated in FIG. 1, a conical portion V13 is formed at one end portion of the body portion V11 of the first valve body V1. In a state where the plunger 3a protrudes by a predetermined length toward the third pilot chamber PR3, the first valve body V1 is pressed against the plunger 3a by the first spring S1, and a gap having a constant width is formed between the first valve body V1 and the first valve seat R3.

By forming the conical portion V13 as described above, when the housing H is pushed to the second fluid chamber 2 side and the internal pressure of the second pilot chamber PR2 becomes higher than the internal pressure of the third pilot chamber PR3, the pressure of the working fluid acts on the inner surface of the conical portion V13 so that the first valve body V1 is pressed against the plunger 3a. On the other hand, when the housing H is pulled to the first fluid chamber 1 side and the internal pressure of the third pilot chamber PR3 becomes higher than the internal pressure of the second pilot chamber PR2, the pressure of the working fluid acts on the outer surface of the conical portion V13 so that the first valve body V1 is pressed against the first valve seat R3. In this way, by configuring the inner surface and the outer surface of the conical portion V13 to have a predetermined shape so that the first valve body V1 is pressed to either side, it is possible to set individual pressure receiving areas for a case where the housing H is pushed and a case where the housing H is pulled and to acquire optimum damping characteristics.

### (Second Valve Body)

As illustrated in FIGS. 1 and 2, the damping force variable valve GV of the present embodiment further includes the second valve body V2 between a wall portion H13 of the first housing H1 and the retainer R. The second valve body V2 has a substantially cup shape, and reciprocates within a predetermined range along the axis X inside the first housing H1. Thereby, by increasing or decreasing a gap with the first housing H1, the second valve body V2 changes the flow rate of the working fluid through the first fluid chamber 1 and the second fluid chamber 2, thereby adjusting a damping effect. As will be described later, the second valve body V2 moves when the movement speed of the housing H relative to the case C is increased and a difference in internal pressure between the first pilot chamber PR1 and the second pilot chamber PR2 becomes greater than a predetermined value, thereby increasing the flow rate of the working fluid through the fluid chamber 1 and the second fluid chamber 2.

A coil-shaped second spring S2 is provided between the bottom surface (the upper side in FIG. 1) of the first housing H1 and the end surface V25 of the second valve body V2, and the second valve body V2 is constantly pressed to the side opposite to the solenoid 4a. An annular vertical wall portion V21 is formed on the outer edge portion of the surface of the bottom portion of the second valve body V2, which faces the second fluid chamber 2 side, and is in contact with an annular second valve seat H11 formed on the first housing H1.

In addition, second slits V24 are formed in the radial direction in the vertical wall portion V21 so as to be dispersed along the circumferential direction of the vertical wall portion V21. Thereby, as illustrated in FIG. 1, even when the vertical wall portion V21 is in contact with the second valve seat H11, the working fluid may slightly circulate through the first fluid chamber 1 and the second fluid chamber 2. As will be described later, the flow rate of the working fluid circulating through the first fluid chamber 1 and the second fluid chamber 2 is changed depending on the distance between the second valve seat H11 and the vertical wall portion V21, whereby a damping effect is adjusted.

A second orifice OR2 is formed in the direction of the axis X through the bottom portion of the second valve body V2. The second orifice OR2 communicates the second pilot chamber PR2 and the second fluid chamber 2 with each other. Each of the second orifice OR2 and the first orifice OR1 is set to have a predetermined opening area so as to allow a predetermined amount of working fluid to circulate therethrough.

The first check valve V3 and a second check valve V4 are provided separately at a position between the first housing H1 and the second housing H2 and on the bottom portion of the second valve body V2. When the working fluid circulates through the first fluid chamber 1 and the second fluid chamber 2, these check valves secure the discharge flow rate of the working fluid discharged to the other fluid chamber.

### (Second Check Valve)

Among these, first, the second check valve V4 will be described. A plurality of fifth ports P5 is formed in the bottom portion of the second valve body V2 in a region on the outer circumferential side of the second orifice OR2 and on the inner circumferential side of the vertical wall portion V21 so as to be formed in the direction of the axis X and dispersed in the circumferential direction. The second check valve V4, which has an annular thin plate shape, is provided on the outer surface of the bottom portion of the second valve body V2 at a position at which it closes the fifth ports P5. The second check valve V4 is normally pressed by, for example, a coil-shaped third spring S3 so as to close the fifth ports P5. When the working fluid is discharged from the second pilot chamber PR2 to the second fluid chamber 2 through the second orifice OR2, the second check valve V4 is opened in a state where the internal pressure of the second pilot chamber PR 2 is increased to overcome the press force of the third spring S3. Thereby, the discharge of the working fluid from the second pilot chamber PR2 is facilitated.

### (First Check Valve)

On the other hand, the first check valve V3 is provided on the bottom portion of the first housing H1. Third ports P3 are provided in the direction of the axis X at a position of the bottom portion of the first housing H1 at which it faces the first pilot chamber PR1. The third ports P3 are dispersed in the circumferential direction around the axis X, and are in communication with an annular space V31 formed between the first housing H1 and the second housing H2, which face each other in the direction of the axis X. Here, the annular space V31 is further in communication with the first fluid chamber 1 through fourth ports P4, which are formed in the radial portion in a wall portion H22 of the second housing H2. The fourth ports P4 are also dispersed in the circumferential direction of the wall portion H22 of the second housing H2.

For example, the first check valve V3, having a thin plate shape, is provided in the annular space V31 at a position at which the third ports P3 open so as to close the third ports P3. The first check valve V3 is fixed between the first housing H1 and the second housing H2 via an annular fixing member V32.

The first check valve V3 is positioned by the fixing member V32, but the first check valve V3 may have elasticity and may be opened by the hydraulic pressure from the third ports P3. That is, when the working fluid is discharged from the first pilot chamber PR1 to the first fluid chamber 1 through the first orifice OR1, the first check valve V3 is opened according to an increase in the internal pressure of the first pilot chamber PR1. Thereby, the discharge of the working fluid from the first pilot chamber PR1 is facilitated.

In the present embodiment, the first check valve V3 is provided between the first housing H1 and the second housing H2, but this may provide the following advantages. In the damping force variable valve GV, since the housing H reciprocates relative to the case C, the circulation direction in which the working fluid circulates inside the housing H is likely to be the direction of the axis X. Therefore, when the movement space of the first check valve V3 is set to the direction of the axis X by causing the circulation direction of the working fluid in the first check valve V3 to be parallel to the axis X as in the present configuration, the flow state of the working fluid becomes smooth.

In addition, the third ports P3 in the first check valve V3 are dispersed along the circumferential direction around the axis X, for example. With this configuration, it is easy to increase the total opening area of the third ports P3 and it is possible to secure a high flow rate of the first check valve V3. In addition, a compact damping force variable valve GV can be obtained in comparison with, for example, a case where a certain check valve is provided at one location of the housing H so as to protrude in the radial direction.

In addition, in a case where the first check valve V3 uses an annular integral body, which is continuous in the circumferential direction of the axis X, as in the present embodiment, a plurality of first check valves V3 may be disposed so as to cover the respective third ports P3 dispersed in the circumferential direction, or may adopt any other arbitrary configuration. For example, by using a flapper valve as the first check valve V3, the first check valve V3, which is thin and has a simplified configuration and is easily reduced in size, may be rationally configured.

As a material constituting the first check valve V3, a resin material, an elastic metal plate or rubber member, or the like may be used.

In addition, in the damping force variable valve GV that performs pilot control as in the present embodiment, in a case where the first housing H1 provided with the first valve body V1 or the like and the second housing H2 provided with the actuator 4 or the like are separately configured, a fitting portion, a screwing portion, or the like for connecting both the members are often provided at the boundary position between the first housing H1 and the second housing H2.

In addition, at the boundary position, a guide hole R1 or the like is formed to enable the smooth reciprocating of the plunger 3a. Normally, a complicated mechanism or the like is rarely disposed at such a boundary position, and a configuration of the corresponding region is often relatively simple. Therefore, by providing the first check valve V3 in such a space, the length of the housing H along the axis X can be shortened, and thus the damping force variable valve GV has a compact configuration. Therefore, a damping force variable valve GV, which is excellent in mountability, can be obtained.

### (Operation Mode of Control Mechanism)

For example, when the rod 6 is pushed downward in FIG. 1 and the housing H begins to compress the second fluid chamber 2, as indicated by the broken line in FIG. 1, the working fluid in the second fluid chamber 2 is introduced into the second pilot chamber PR2 from the second orifice OR2, reaches the third pilot chamber PR3 through the first slit V15 between the plunger 3a and the first valve body V1 or the gap between the first valve body V1 and the first valve seat R3, and is then discharged to the first pilot chamber PR1 through the first port P1 and the second port P2 and to the first fluid chamber 1 through the first orifice OR1. At this time, the first check valve V3 may be opened.

On the other hand, when the rod 6 is pulled upward in FIG. 1 and the housing H begins to compress the first fluid chamber 1, the working fluid in the first fluid chamber 1 flows in the direction opposite to the direction indicated by the broken line in FIG. 1, is introduced into the first pilot chamber PR1 from the first orifice OR1, reaches the third pilot chamber PR3 through the first port P1 and the second port P2, and is then discharged to the second pilot chamber PR2 through the first slit V15 between the plunger 3a and the first valve body V1 or the gap between the first valve body V1 and the first valve seat R3 and to the second fluid chamber 2 through the second orifice OR2. At this time, the second check valve V4 may be opened against the press force of the third spring S3.

When the housing H moves upward in FIG. 1, the internal pressure of the first pilot chamber PR1 is increased due to the working fluid introduced through the first orifice OR1. However, since the flow rate of the working fluid passing through the first orifice OR1 is limited to a certain amount, the rate of increase in the internal pressure of the first pilot chamber PR1 is suppressed to a predetermined speed. However, since the pressure of the working fluid acting on a sixth port P6 abruptly increases when the upward movement speed of the housing H is high, the pressure acting on an outer peripheral surface V22 of the bottom portion of the second valve body V2 becomes greater than the pressure acting on the end surface V25 of the second valve body V2 inside the first pilot chamber PR1. Thus, the second valve body V2 is separated from the second valve seat H11 against the press force of the second spring S2, and as indicated by the broken line in FIG. 2, the working fluid is introduced into the second fluid chamber 2 through the resulting gap.

The pressure required to move the second valve body V2 using the pressure of the working fluid acting on the sixth port P6 is determined by the position of the plunger 3a. That is, the more the plunger 3a protrudes to the third pilot chamber PR3 side, the gap between the first valve body V1 and the first valve seat R3 is reduced. Accordingly, the working fluid flowing out from the third pilot chamber PR3 to the second pilot chamber PR2 is pressed, and the internal pressure of the first pilot chamber PR1 is rapidly increased when the working fluid is introduced into the first pilot chamber PR1 through the first orifice OR1. In this case, since a difference between the pressure acting on an outer surface V23 of the bottom portion of the second valve body V2 and the pressure acting on the end surface V25 of the second valve body V2 is small, the second valve body V2 is difficult to be opened. As a result, the flow rate of the working fluid discharged from the first fluid chamber 1 to the second fluid chamber 2 is limited, whereby a damping effect caused by the operation of the housing H is enhanced.

When the housing H moves downward in FIG. 1, the internal pressure of the second pilot chamber PR 2 is increased by the working fluid introduced through the second orifice OR2. However, since the flow rate of the working fluid passing through the second orifice OR2 is limited to a certain amount, the rate of increase in the internal pressure of the second pilot chamber PR2 is suppressed to a predetermined speed. However, since the pressure of the working fluid acting on the outer surface V23 of the bottom portion of the second valve body V2 abruptly increases when the downward movement speed of the housing H is high, the pressure acting on the outer surface V23 becomes greater than the pressure acting on an inner surface V26 of the bottom portion of the second valve body V2 inside the second pilot chamber PR2. Therefore, the second valve body V2 is separated from the second valve seat H11 against the press force of the second spring S2, and the working fluid flows toward the first fluid chamber 1 through the resulting gap. Thereby, when a great downward force acts on the housing H, the housing H may be relatively quickly moved downward.

Even when the housing H moves downward, the pressure required for separating the second valve body V2 is determined by the position of the plunger 3a. The more the plunger 3a protrudes to the third pilot chamber PR3 side, the smaller the gap between the first valve body V1 and the first valve seat R3. Thus, the working fluid flowing out from the second pilot chamber PR2 to the third pilot chamber PR3 is pressed, and the internal pressure of the second pilot chamber PR2 is rapidly increased when the working fluid is introduced into the second pilot chamber PR2 through the second orifice OR2. In this case, there is a small difference with the pressure acting on the outer surface V23 of the bottom portion of the second valve body V2, and the second valve body V2 is difficult to be opened. As a result, the flow rate of the working fluid discharged from the second fluid chamber 2 to the first fluid chamber 1 is limited, and a damping effect caused by the operation of the housing H is enhanced.

In addition, by setting a difference between the inner diameter of the first orifice OR1 and the inner diameter of the second orifice OR2, it is possible to differentiate a damping effect depending on the operation direction of the housing H. For example, when the inner diameter of the first orifice OR1 is set to be larger than the inner diameter of the second orifice OR2, the degree at which the internal pressure of the first pilot chamber PR1 is increased becomes larger than the degree at which the internal pressure of the second pilot chamber PR2 is increased. In other words, when the housing H moves upward and the internal pressure of the first pilot chamber PR1 is increased, there is a small difference with the pressure acting on the outer surface V23 of the bottom portion of the second valve body V2 through the sixth port P6, and the amount of movement of the valve body V2 is reduced. Thus, in this case, a damping effect of the housing H is enhanced.

In addition, when the solenoid 4a fails, the control mechanism 5 operates as follows.

The plunger 3a is pushed by the first valve body V1 by the press force of the first spring S1, and retracts to the second housing H2 side. As a result, the first valve body V1 moves to a position at which it comes into contact with the bottom portion of the first housing H1, and the first port P1 is shielded by the flange portion V12 of the first valve body V1. Thereby, the first pilot chamber PR1 and the third pilot chamber PR3 communicate with each other only through the second port P2. The opening area of the second port P2 is set to be a predetermined size, and is set to be smaller than the opening area of the first orifice OR1 or the area of the gap between the first valve body V1 and the first valve seat R3. Thus, when the solenoid 4a falls, the flow of the working fluid is controlled by the second port P2.

### Second Embodiment

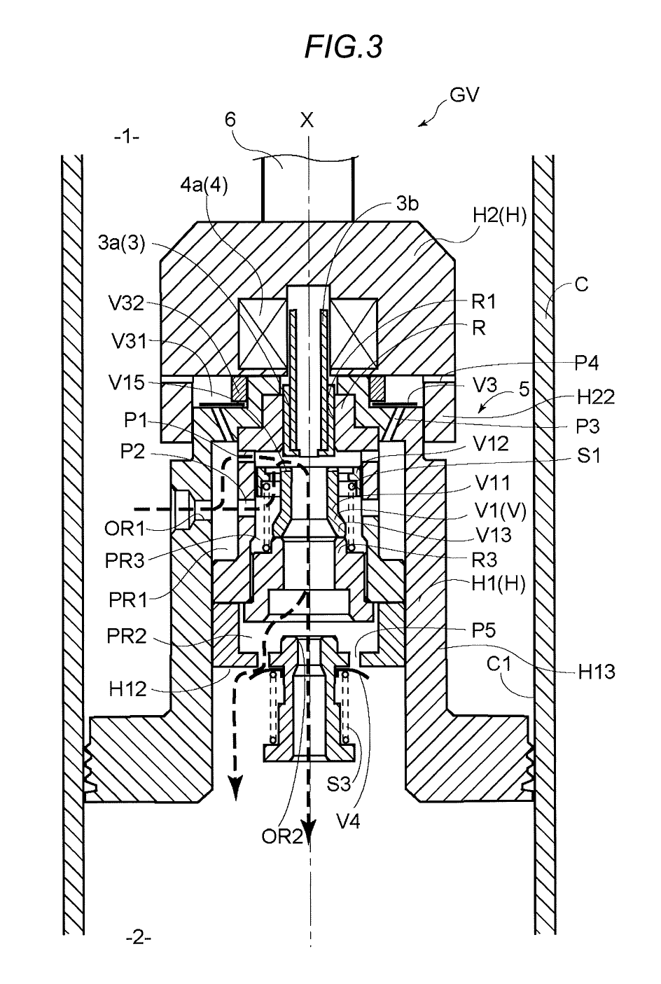

The damping force variable valve GV disclosed here may also be configured without the second valve body V2, as illustrated in FIG. 3. As illustrated in FIG. 3, the second orifice OR2 is formed in an end surface H12 of the first housing H1. In addition, the second check valve V4 is provided around the second orifice OR2.

In the case of this configuration, as illustrated in the above paragraphs [0058] and [0059], a buffering function caused by the operation of the housing H is based only on adjustment of the position of the first valve body V1. Thus, compared to a case of the first embodiment in which the second valve body V2 is opened and closed, the range within which the operation speed of the housing H is changed is small. Thus, in a case of the present embodiment, for example, the first valve body V1 may be set to a large stroke range, so that the amount of change in the distance between the first valve body V1 and the plunger 3a or the distance between the first valve body V1 and the first valve seat R3 is increased so as to secure the range of control in the flow rate of the working fluid. To this end, the opening areas or the like of the first orifice OR1, the second orifice OR2, the first port P1, and the second port P2 are appropriately set according to the specifications of the first valve body V1. In addition, the broken line in the drawing illustrates the path of circulation of the working fluid when the housing H moves upward.

In this case, the length of the housing H is shortened by the extent that the second valve body V2 is omitted. In addition, as in the first embodiment, since the first check valve V3 is particularly formed between the first housing H1 and the second housing H2, it is possible to further shorten the length of the entire housing H and to acquire a compact damping force variable valve GV.

### Third Embodiment

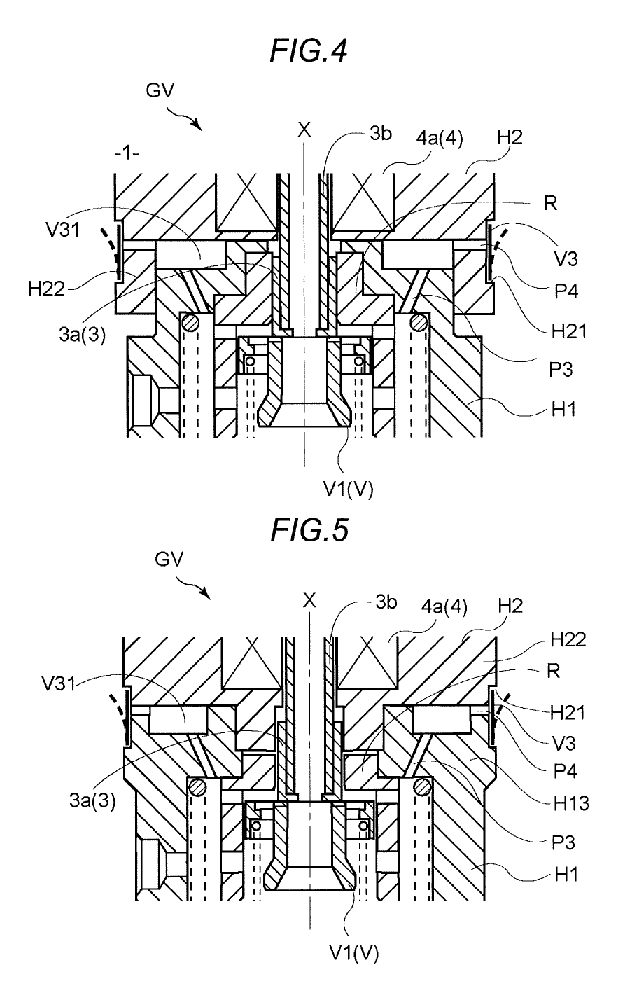

As illustrated in FIG. 4, the first check valve V 3 may be provided on the fourth ports P4. That is, an opening, through which the working fluid is discharged to the first fluid chamber 1, is formed in the radial direction with respect to the axis X.

The fourth ports P4 open in the outer peripheral surface of the second housing H2, and are dispersed along the circumferential direction. The cross-sectional shape of the fourth ports P4 when viewing the fourth ports P4 in the radial direction with respect to the axis X may be a circular shape, for example, or may be an elongated oval shape in the circumferential direction of the second housing H2. The first check valve V3 may be a single annular valve body that shields the plurality of fourth ports P4, for example, or may be individual valve bodies for individually shielding the respective fourth ports P4. FIG. 4 illustrates an example in which a single annular valve body formed of a rubber material, for example, is provided.

In order to prevent the first check valve V3 from protruding from the outer peripheral surface of the second housing H2, an annular recess H21 is formed in the outer peripheral surface of the second housing H2. The first check valve V3 is fitted into the recess H21 so that no protrusion appears on the surface of the second housing H2. With this configuration, the radial dimension of the second housing H2 can be suppressed, and since the distance between the outer peripheral surface of the second housing H2 and the inner surface C1 of the case C is reduced, the overall outer diameter dimension can be reduced and the damping force variable valve GV, which is excellent in mountability, can be obtained.

In addition, as illustrated in FIG. 4, the recess H21 may be provided so as to be offset from the fourth port P4 to the first housing H1 side. The edge portion of the first check valve V3 on the first housing H1 side is fixed by adhesion or the like, and the opposite edge portion remains so as to be opened and closed. This is because this configuration serves to prevent the first check valve V3, which has been opened, from coming into contact with the inner surface C1 of the case C and being unnecessarily deformed. That is, the first check valve V3 is opened when the second housing H2 moves to the second fluid chamber 2 side. Therefore, when the tip end portion of the first check valve V3 having an enlarged diameter comes into contact with the inner surface of the second housing H2, the tip end portion is located behind the fixed distal end portion in the movement direction so as to prevent connection therebetween.

### Fourth Embodiment

In addition, in FIG. 4, the fourth port P4 opens to the outer surface of the second housing H2, but, as illustrated in FIG. 5, the fourth port P4 may be configured by both the wall portions H13 and H22 of the first housing H1 and the second housing H2. In that case, the first check valve V3 is provided on both the first housing H1 and the second housing H2. In addition, according to a configuration of the fitting portion or the screwing portion of the first housing H1 and the second housing H2, the fourth port P4 may open to the outer surface of the first housing H1, and the first check valve V3 may be provided therein.

The formation of the first check valve V3 in which the fourth port P4 is formed in the radial direction as described above is advantageous in a case where the limitation of the size in the direction along the axis X is severe by, for example, the spatial limitation of the position, to which the damping force variable damper GV is attached, or a case where it is desired to secure the stroke of the housing H as long as possible.

### Other Embodiment

The first check valve V3 and the second check valve V4 may have other different forms, such as a poppet valve. In conclusion, any form may be used as long as the mounting space of each check valve may be made compact, and the opening and closing function thereof may be exerted surely.

The first valve body V1 may be of a rotation type, instead of a type of reciprocating along the direction of the axis X. Although not illustrated, a motor as the actuator may rotate the first valve body V1 via a shaft member to change the circulation area with the second pilot chamber PR2 and the third pilot chamber PR3.

With this configuration, it is unnecessary to reciprocate the first valve body V1 along the direction of the axis X, and it is possible to further shorten the length of the second housing H2.

In the above-described embodiment, a configuration in which the housing H reciprocates relative to the case C is described, but the housing H may be fixed inside the case C. For example, the damping force variable valve GV may be provided in a state of dividing the inside of the case C into the first fluid chamber 1 and the second fluid chamber 2, and the working fluid may move between the first fluid chamber 1 and the second fluid chamber 2 by a separate piston or the like provided inside the case C.

The damping force variable valve disclosed here may be, for example, a valve that divides the inside of a case into a first fluid chamber and a second fluid chamber and adjusts the flow rate of a working fluid through the first fluid chamber and the second fluid chamber, and may be widely applied.

### (Configuration)

A feature of a damping force variable valve according to an aspect of this disclosure resides in that the damping force variable valve includes a case that accommodates a working fluid therein, and a housing that divides an inside of the case into a first fluid chamber and a second fluid chamber. The housing includes a first housing and a second housing, which are adjacent to each other along a direction of an axis of the case. Inside the first housing, a control mechanism that controls an operation speed of the housing by adjusting a flow rate of the working fluid circulating through the first fluid chamber and the second fluid chamber is provided. The control mechanism includes a first pilot chamber that communicates with the first fluid chamber through a first orifice, a second pilot chamber that communicates with the second fluid chamber through a second orifice, and a valve body that changes a posture while separating the first pilot chamber and the second pilot chamber from each other. Inside the second housing, an adjustment mechanism which adjusts a degree of change in the posture of the valve body so as to set an amount of circulation of the working fluid through the first pilot chamber and the second pilot chamber, and an actuator which drives the adjustment mechanism are provided. A check valve that is opened when an internal pressure of the first pilot chamber is increased so as to discharge the working fluid from the first pilot chamber to the first fluid chamber is provided at a boundary position between the first housing and the second housing.

### (Effect)

In the damping force variable valve that performs pilot control as in this configuration, when the first housing provided with the valve body or the like and the second housing provided with the actuator or the like are separately configured, a fitting portion or the like is often disposed at a boundary position between the first housing and the second housing in order to connect both the members.

In addition, at the boundary position, a guide portion or the like is formed in order to smoothly reciprocate the adjustment mechanism. Normally, a complicated mechanism or the like is rarely disposed at such a boundary position, and the configuration of the corresponding region is often relatively simple. Therefore, by providing the check valve using such a space, the axial length of the housing is shortened, and a damping force variable valve is configured to be compact. Therefore, the leakage or the like of the working fluid is difficult to occur, so that a good buffering function can be exerted and a damping force variable valve, which is excellent in mountability, can be obtained.

### (Configuration)

In the damping force variable valve according to the aspect of this disclosure, the check valve may include an opening provided along a circumferential direction around the axis.

### (Effect)

Such a check valve may be provided, for example, at only one position in the circumferential direction of the housing. However, in that case, it is difficult to secure a sufficiently large opening area of the check valve. Therefore, by providing the openings in the check valve in the circumferential direction around the axis as in the present configuration, the opening area may be enlarged and it is possible to secure a required flow rate of the check valve. In addition, it is possible to obtain a damping force variable valve having a small size, in compared with, for example, a case where the check valve is provided so as to protrude in the circumferential direction of the housing.

### (Configuration)

In the damping force variable valve according to the aspect of this disclosure, the opening in the check valve may be configured such that a circulation direction in which the working fluid circulates through the opening is parallel to the axis.

### (Effect)

In the damping force variable valve, since the housing reciprocates relative to the case, the circulation direction in which the working fluid circulates inside the housing also tends to be along the direction of the axis. Therefore, when the movement space of the check valve is set to the direction of the axis by causing the circulation direction of the working fluid in the check valve to be parallel to the axis as in the present configuration, the flow state of the working fluid becomes smooth.

In addition, with this configuration, the outer diameter dimension of the housing can be easily reduced, and a damping force variable valve, which is excellent in mountability, can be obtained.

In the case of this configuration, the check valve may be an annular integral body, which is continuous in the circumferential direction of the axis. Alternatively, an arbitrary configuration in which a plurality of check valves is dispersed in the circumferential direction, or the like, may be adopted.

### (Configuration)

In the damping force variable valve according to the aspect of this disclosure, the opening in the check valve may be configured such that a circulation direction in which the working fluid circulates through the opening is a radial direction with respect to the axis.

### (Effect)

Due to the spatial limitation of the position to which the damping force variable valve is attached, or the like, there is a case where the size limitation in the direction along the axis is severe, or a case where it is desired to secure the stroke of the housing as long as possible. In such a case, it is advantageous to configure the openings in the check valve so as to face the radial direction as in the present configuration.

In addition, even in this case, an arbitrary configuration, in which an annular integral body formed of an elastic member is used as the valve body, or a plurality of check valves is dispersed along the circumferential direction, or the like may be adopted.

### (Configuration)

In the damping force variable valve according to the aspect of this disclosure, the valve body of the check valve may be provided in a state of being fitted into a recess, which is provided in an outer peripheral surface of at least one of the first housing and the second housing.

### (Effect)

Even when the radial size of the damping force variable valve has a certain degree of freedom and it is permissible to orient the openings in the check valve in the radial direction, the smaller radial dimension of the damping force variable valve is advantageous for mountability or the like. Therefore, in a case where the valve body is provided on the outer peripheral surface of the first housing or the like as in the present configuration, the radial dimension of the housing may be suppressed by forming the recess, into which the valve body is fitted, in the outer peripheral surface. Thereby, the distance between the outer peripheral surface of the housing and the inner surface of the case is reduced, so that the overall outer diameter dimension can be reduced and a damping force variable valve, which is excellent in mountability, can be obtained.

### (Configuration)

In the damping force variable valve according to the aspect of this disclosure, the check valve may be a flapper valve.

### (Effect)

The flapper valve may be configured using a thin rubber member or the like, and it is possible to easily reduce the size of the valve body. In addition, since the flapper valve has a simplified structure and is inexpensive, the check valve may be rationally configured.

### (Configuration)

In the damping force variable valve according to the aspect of this disclosure, the valve body may be movable along the axis, the actuator may be a solenoid, and the adjustment mechanism may be a plunger which includes a bar-shaped member connected to the solenoid, and is movable along the axis.

### (Effect)

In this configuration, the plunger having the bar-shaped member is provided to adjust the posture of the valve body. Such a bar-shaped member easily transmits the driving effect of the solenoid to the valve body, which is located at a position that is spaced apart from the solenoid by a predetermined distance. When the bar-shaped member mainly transmits the driving force along the direction of the axis, the outer diameter dimension of the bar-shaped member may be smaller than the outer diameter dimension of the solenoid or the valve body. The periphery of the bar-shaped member is used as a guide portion of the bar-shaped member inside the second housing, but another space is easily secured since the bar-like member is relatively thin. Therefore, with this configuration, it is easy to secure the space for the installation of the check valve, and it is easy to obtain a more compact damping force variable valve.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A damping force variable valve comprising:
a case that accommodates a working fluid therein; and
a housing that divides an inside of the case into a first fluid chamber and a second fluid chamber,
wherein the housing includes a first housing and a second housing, which are adjacent to each other along a direction of an axis of the case,
inside the first housing, a control mechanism that controls an operation speed of the housing by adjusting a flow rate of the working fluid circulating through the first fluid chamber and the second fluid chamber is provided,
the control mechanism includes:
a first pilot chamber that communicates with the first fluid chamber through a first orifice;
a second pilot chamber that communicates with the second fluid chamber through a second orifice; and
a valve body that changes a posture while separating the first pilot chamber and the second pilot chamber from each other, and
inside the second housing, an adjustment mechanism which adjusts a degree of change in the posture of the valve body so as to set an amount of circulation of the working fluid through the first pilot chamber and the second pilot chamber, and an actuator which drives the adjustment mechanism are provided, and
a check valve that is opened when an internal pressure of the first pilot chamber is increased so as to discharge the working fluid from the first pilot chamber to the first fluid chamber is provided at a boundary position between the first housing and the second housing.

2. The valve according to claim 1,
wherein the check valve includes an opening provided along a circumferential direction around the axis.

3. The valve according to claim 2,
wherein the opening in the check valve is configured such that a circulation direction in which the working fluid circulates through the opening is parallel to the axis.

4. The valve according to claim 2,
wherein the opening in the check valve is configured such that a circulation direction in which the working fluid circulates through the opening is a radial direction with respect to the axis.

5. The valve according to claim 4,
wherein the valve body of the check valve is provided in a state of being fitted into a recess, which is provided in an outer peripheral surface of at least one of the first housing and the second housing.

6. The valve according to claim 1,
wherein the check valve is a flapper valve.

7. The valve according to claim 2,
wherein the check valve is a flapper valve.

8. The valve according to claim 3,
wherein the check valve is a flapper valve.

9. The valve according to claim 4,
wherein the check valve is a flapper valve.

10. The valve according to claim 5,
wherein the check valve is a flapper valve.

11. The valve according to claim 1,
wherein the valve body is movable along the axis, the actuator is a solenoid, and the adjustment mechanism is a plunger which includes a bar-shaped member connected to the solenoid and is movable along the axis.
